(19) United States
(12) Patent Application Publication
(10) Pub. No.: US 2015/0048964 A1
(43) Pub. Date: Feb. 19, 2015

(54) MILLIMETER WAVE THREE DIMENSIONAL HOLOGRAPHIC SCAN IMAGING APPARATUS AND INSPECTING METHOD THEREOF

(71) Applicants: Nuctech Company Limited, Beijing (CN); Tsinghua University, Beijing (CN)

(72) Inventors: Zhiqiang Chen, Beijing (CN); Yuanjing Li, Beijing (CN); Ziran Zhao, Beijing (CN); Wanlong Wu, Beijing (CN); Zongjun Shen, Beijing (CN); Yinong Liu, Beijing (CN); Li Zhang, Beijing (CN); Xianli Ding, Beijing (CN)

(21) Appl. No.: 14/451,260

(22) Filed: Aug. 4, 2014

(30) Foreign Application Priority Data
Aug. 15, 2013 (CN) 201310356862.3

(51) Int. Cl. G01S 13/89; G01S 13/88

(52) U.S. Cl. CPC G01S 13/89; G01S 13/887
USPC 342/22

(57) ABSTRACT

A millimeter wave three dimensional holographic scan imaging apparatus and a method for inspecting an object to be inspected using the same are disclosed. The apparatus includes a millimeter wave transceiver module with a millimeter wave transceiver antenna array for transmitting and receiving a millimeter wave signal. The apparatus also includes a guide rail device, to which the millimeter wave transceiver module is connected in slidable form. The millimeter wave transceiver module is moveable along the guide rail device to perform a plane scan on an object to be inspected. A data processing device generates a millimeter wave holographic image from the plane scan.

### CROSS-REFERENCE TO RELATED APPLICATION

This application claims priority to Chinese Patent Application No. 201310356862.3 filed on Aug. 15, 2013, entitled “MILLIMETER WAVE THREE DIMENSIONAL HOLOGRAPHIC SCAN IMAGING APPARATUS AND INSPECTING METHOD THEREOF,” in the State Intellectual Property Office of China, the disclosure of which is incorporated herein by reference in its entirety.

### BACKGROUND OF THE INVENTION

1. Field of the Invention

The disclosed technology generally relates to a technical field of human body security inspection, in particular to a millimeter wave three dimensional holographic scan imaging apparatus and a method for inspecting an object to be inspected using the same.

2. Description of the Related Art

Inspection systems use X-ray, passive millimeter wave, or active millimeter wave imaging technology to inspect human bodies or articles (or, collectively, objects). For example, cylindrical scan imaging systems at, for example, airports, form holographic images using active millimeter wave imaging technology. Cylindrical scanners at airports are large and typically use a long vertical antenna array with many antennas, thereby increasing the cost of the scanner. Each passenger stands in a first position and is scanned by the single side scan imager that inspects one side of the passenger. The passenger turns so that the other side of the passenger can be scanned. Complex algorithms process the pair of cylindrical scans taken with the long vertical array of antennas to create holographic images.

There is a need to scan passengers or objects more quickly, more efficiently, and at lower cost. This may be accomplished with millimeter wave three dimensional holographic imaging apparatus that do not require that the passenger move between scans, with scanners with smaller and less expensive planar arrays of antennas that take planar scans (and simpler algorithms), and that are more compact than existing cylindrical scanners.

### SUMMARY OF CERTAIN INVENTIVE ASPECTS

One object of certain embodiments of the disclosed technology is to provide a millimeter wave three dimensional holographic scan imaging apparatus that scans images rapidly and efficiently.

A further object of certain embodiments of the disclosed technology is to provide a method for inspecting a human body or an article using the millimeter wave three dimensional holographic scan imaging apparatus which can perform the inspection globally, conveniently and fast. It is in particular suitable to various applications of security inspection for a human body or an article.

To this end, the disclosed technology may be implemented by the following.

One aspect of the disclosed technology is a millimeter wave three dimensional holographic scan imaging apparatus. The apparatus includes a millimeter wave transceiver module comprising a millimeter wave transceiver antenna array for transmitting and receiving a millimeter wave signal. The apparatus also includes a guide rail device, to which the millimeter wave transceiver module is connected in slidable form, such that the millimeter wave transceiver module is moveable along the guide rail device to perform a scan on an object to be inspected. The scan performed by the millimeter wave transceiver module is a plane scan.

For some embodiments, a transmitting face and a receiving face of the millimeter wave transceiver antenna array both may be substantially located on the same plane. The plane may be rectangle-shaped or square-shaped in a cross-sectional view.

For some embodiments, the millimeter wave transceiver module may include a millimeter wave transceiver circuit connected to the millimeter wave transceiver antenna array.

For some embodiments, the millimeter wave transceiver antenna array may comprise at least one row of millimeter wave transmitting antennas and at least one row of millimeter wave receiving antennas. The row of millimeter wave transmitting antennas may comprise a plurality of millimeter wave transmitting antennas spaced from each other with a first predetermined distance in the row. The row of millimeter wave receiving antennas may comprise a plurality of millimeter wave receiving antennas spaced from each other with a second predetermined distance in the row. The first predetermined distance may be identical to or different from the second predetermined distance.

For some embodiments, when the first predetermined distance is identical to the second predetermined distance, the millimeter wave transmitting antennas in the row of the millimeter wave transmitting antennas and the corresponding millimeter wave receiving antennas in its adjacent row of the millimeter wave receiving antennas may be staggered or aligned, in a direction perpendicular to an extending direction of the row of the millimeter wave transmitting and/or receiving antennas.

For some embodiments, the millimeter wave three dimensional holographic scan imaging apparatus may further comprise a driver, by which the millimeter wave transceiver module is connected with the guide rail device, thereby driving the millimeter wave transceiver module to move along the guide rail device.

For some embodiments, the millimeter wave three dimensional holographic scan imaging apparatus may further comprise a driver, wherein the millimeter wave transceiver module is directly connected with the guide rail device, and the driver drives the millimeter wave transceiver module to move along the guide rail device, by other means.

For some embodiments, the guide rail device may be arranged along a vertical direction, a horizontal direction or in any oblique direction; and accordingly the millimeter wave transceiver module moves along a vertical direction, a horizontal direction or in any oblique direction.

For some embodiments, the guide rail device may be composed of one guide rail or a plurality of guide rails parallel to each other.

For some embodiments, the millimeter wave three dimensional holographic scan imaging apparatus may also include a data processing device communicated by wire or wireless to the millimeter wave transceiver module to receive scan data from the millimeter wave transceiver module and to generate a millimeter wave holographic image. The imaging apparatus may also include a display device communicated to the data processing device to receive and display the millimeter wave holographic image from the data processing device.

For some embodiments, the data processing device may be configured to generate a control signal and transmit it to the driver to allow the driver to drive the millimeter wave transceiver module to move. For some embodiments, the millimeter wave three dimensional holographic scan imaging apparatus may also include a separate controller with respect to the data processing device, the separate controller configured to generate a control signal and transmit it to the driver to allow the driver to drive the millimeter wave transceiver module to move.

Another aspect of the present invention is a method for inspecting an object to be inspected using a millimeter wave three dimensional holographic scan imaging apparatus as described above. The method includes locating the object to be inspected at an inspection position. The method also includes setting a millimeter wave transceiver module at its scan beginning position. The method also includes driving the millimeter wave transceiver module to move from its scan beginning position to its scan end position along a guide rail device continuously or discontinuously to finish scanning the object to be inspected. The method also includes transmitting data sampled by the millimeter wave transceiver module during the scanning to a data processing device. The method also includes processing the data received from the millimeter wave transceiver module using the data processing device to generate a millimeter wave holographic image of the object to be inspected. The scanning performed by the millimeter wave transceiver module is a plane scan.

For some implementations, the millimeter wave transceiver module may discontinuously move during the scanning operation. For some implementations, two dimensional scanning of the object to be inspected is performed by changing the transmitting frequency of the millimeter wave or altering the current transmitting or receiving antenna in the millimeter wave transceiver module. The whole three dimensional scanning data are obtained by a combination of the two dimensional scanning and the discontinuous movement of the millimeter wave transceiver module.

For some implementations, during the scanning, the millimeter wave transceiver module may continuously move during the scanning operation, and a three dimensional scanning is performed several times for the object to be inspected, by changing the transmitting frequency of the millimeter wave, and altering the current transmitting and/or receiving antenna in the millimeter wave transceiver module, thereby obtaining the whole three dimensional scanning data from results of the several scanning.

For some implementations, the millimeter wave transceiver module may transmit information obtained by processing the millimeter wave signal received from one or more receiving antennas in the millimeter wave transceiver antenna array to the data processing device in real time, or may transmit the information to the data processing device piecewise after it is buffered, or may transmit the information to the data processing device at one time after it is buffered.

For some embodiments, after generating the millimeter wave holographic image of the object to be inspected, an automatic identification on whether the object to be inspected entrains suspected objects and on the position of the suspected objects is carried out and the identified results are outputted.

Another aspect of the disclosed technology is a millimeter wave three dimensional holographic scan imaging apparatus. The apparatus includes a millimeter wave transceiver module comprising a millimeter wave transceiver antenna array configured to transmit and receive a millimeter wave signal. The apparatus also includes a guide rail device, to which the millimeter wave transceiver module is connected in slidable form, such that the millimeter wave transceiver module is moveable along the guide rail device to perform a plane scan on an object to be inspected.

Another aspect of the disclosed technology is a method for inspecting an object using a millimeter wave three dimensional holographic scan imaging apparatus. The method includes setting a millimeter wave transceiver module at its scan beginning position. The method also includes generating a plane scan of an object including a plurality of data samples by driving the millimeter wave transceiver module from a scan beginning position to a scan end position along a guide rail. The method also includes transmitting the plurality of data samples sampled by the millimeter wave transceiver module during generation of the plane scan to a data processing device. The method also includes generating a millimeter wave holographic image of the object by processing the plurality of data samples.

Another aspect of the disclosed technology is a millimeter wave three dimensional holographic scan imaging apparatus. The apparatus includes means for transmitting and receiving a millimeter wave signal. The apparatus also includes means for moving in slidable form the transmitting and receiving means to perform a plane scan on an object to be inspected.

On the basis of at least one of the above aspects, the plane scan can be performed for the object to be inspected. Therefore, correspondingly, the millimeter wave three dimensional holographic scan imaging apparatus has a relatively small volume. In addition, the imaging apparatus can be made in a rectangle or square shape, and thus has a reduced footprint and adapts for many occasions.

Moreover, the millimeter wave three dimensional holographic scan imaging apparatus in accordance with the present invention has a simple and accurate image reconstruction algorithm, thereby improving the imaging speed and accuracy. Further, due to the use of the plane scan type inspection means, it is possible to reduce the length of the antenna array in the millimeter wave transceiver module, and reduce cost.

### BRIEF DESCRIPTION OF THE DRAWINGS

The solutions according to the disclosed technology will be described in detail with reference to the drawings, in which:

FIG. 1 shows an exemplary millimeter wave three dimensional holographic scan imaging apparatus according to an embodiment of the disclosed technology;

FIG. 2 is a structural schematic view of the millimeter wave transceiver module as shown in FIG. 1; and

FIG. 3 is a flowchart illustrating a method for inspecting an object in accordance with the disclosed technology

### DETAILED DESCRIPTION OF CERTAIN ILLUSTRATIVE EMBODIMENTS

Technical features and effects of the solutions according to the disclosed technology, which is directed to a millimeter wave three dimensional holographic scan imaging apparatus and a method for inspecting an object to be inspected using the same, will be explained in exemplary embodiments with reference to the attached drawings. It should be noted that similar reference numbers denote similar structures. The terms “first”, “second”, “upper”, and “lower” may be used in the present application for describing various structures of the device and various steps of the process. However, these words do not imply any spatial, sequential or hierarchy relation of various structures of the device and various steps of the process, unless the context clearly indicates otherwise.

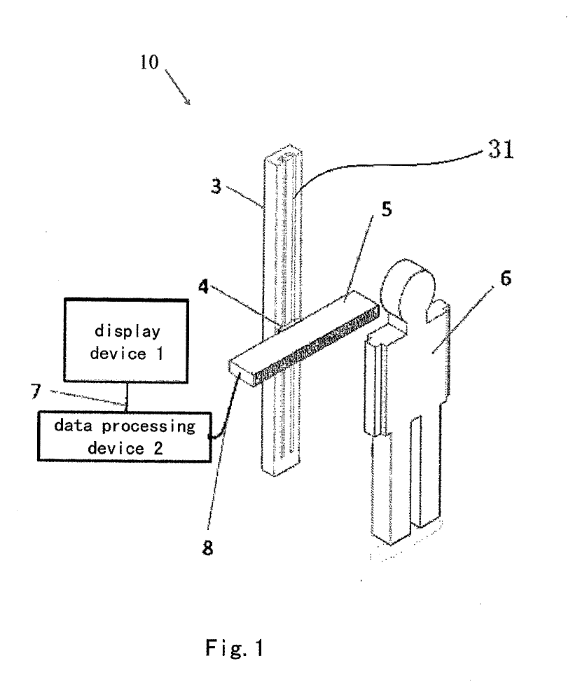

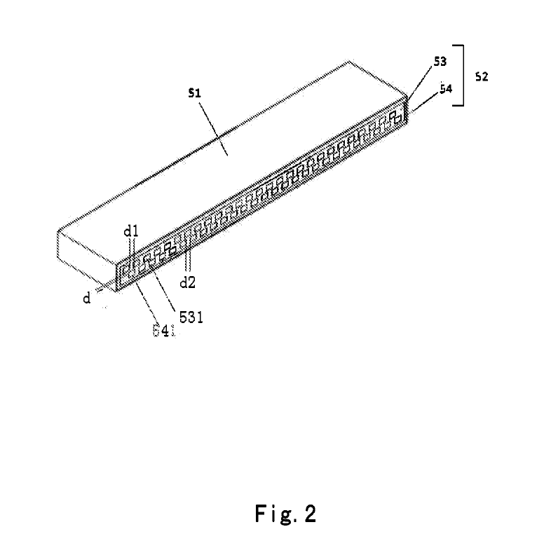

FIG. 1 shows schematically an exemplary millimeter wave three dimensional holographic scan imaging apparatus 10 according to an embodiment of the disclosed technology. It may include a millimeter wave transceiver module 5, a guide rail device 3, and a driver 4 (to be provided if necessary). The millimeter wave transceiver module 5 comprises a millimeter wave transceiver antenna array 52 (as shown in FIG. 2) for transmitting and receiving a millimeter wave signal. The millimeter wave transceiver module 5 is connected in slidable form to the guide rail device 3, such that the millimeter wave transceiver module 5 can move along the guide rail device 3 to perform a scan on an object 6 to be inspected.

For some embodiments, the millimeter wave three dimensional holographic scan imaging apparatus 10 may scan one surface of the object 6 to be inspected at a time, for example a front face, a side face and a back face of the object 6. Scanning a plurality of faces of object 6, may be accomplished by simply moving the millimeter wave three dimensional holographic scan imaging apparatus, turning the object 6, or overturning object 6. Therefore, the manufacturing cost of the millimeter wave three dimensional holographic scan imaging apparatus 10 can be reduced, because it is not necessary to provide multiple millimeter wave transceiver antenna arrays or complicated rotational equipment as provided in cylindrical scanners in the prior art.

The scanning which is performed by the millimeter wave transceiver module is a plane scan, rather than the cylindrical scan. As compared to the cylindrical scan, the millimeter wave holographic imaging algorithm necessary for the plane scan is relatively simple and more accurate. Furthermore, the plane scan can be performed along any scanning directions (for example, a vertical, horizontal or oblique direction, and so on). In contrast, the cylindrical scan can only be performed along arched traces in a horizontal direction. Therefore, with the plane scan, the technical solution of the disclosed technology is more flexible than existing cylindrical scanners.

As shown in FIG. 1, a driver 4 may connect the millimeter wave transceiver module 5 with the guide rail device 3. In this way, the millimeter wave transceiver module 5 along with the driver 4 can slide along a guide rail 31 in the guide rail device 3 from one end thereof to the other end thereof, under the constraint of the guide rail 31. In some implementations the millimeter wave transceiver module 5 is directly connected to the guide rail 31 in the guide rail device 3, without the driver 4. In this case, the millimeter wave transceiver module 5 can slide along the guide rail 31 by mechanical devices (not shown) such as a pulley and a motor connected therewith. The driver 4 or other type of drivers such as the pulley and the motor can be directly controlled by a data processing device 2 as described below, or indirectly controlled by the data processing device 2 via an electric control system.

Although the scanning direction of the millimeter wave transceiver module 5 as shown in FIG. 1 is vertical (up and down in in FIG. 1), the skilled person in the art should understand that the scanning direction can be horizontal or oblique. The scanning direction of the millimeter wave transceiver module 5 can be varied by changing the extending direction of the guide rail device 3. Specifically, as shown in FIG. 1, when the extending direction of the guide rail 3 is the vertical direction, the millimeter wave transceiver module 5 must scan along the vertical direction. A base (not shown in figures) housing the guide rail device 3 may extend the guide rail 31 of the guide rail device 3 along the vertical direction, the horizontal direction, or other any oblique direction. Accordingly, the plane scan of the millimeter wave transceiver module 5 along the vertical direction, the horizontal direction, or any other oblique direction is disclosed herein.

Since the length of the millimeter wave transceiver antenna array 52 in the millimeter wave transceiver module 5 is limited, some implementations determine the scanning direction depending on the object to be scanned, especially for elongated objects, in order to make full use of the length of the millimeter wave transceiver antenna array 52. For example, the scanning direction can be set to be variable, so as to adjust the scanning direction based on the object to be scanned. This cannot be accomplished by cylindrical scanners.

In order to perform the plane scan, a transmitting face and a receiving face of the millimeter wave transceiver antenna array 52 are located on the same plane (Le., the plane facing to the object 6 to be inspected as shown in FIG. 1). The plane may be rectangular or square in the view of FIG. 2. The rectangular or square shapes are not limiting; other implementations use other shapes such as circular, oval, or polygonal.

As shown in FIG. 2, the millimeter wave transceiver module 5 further includes a millimeter wave transceiver circuit 51 connected to and cooperating with the millimeter wave transceiver antenna array 52. Specifically, the millimeter wave transceiver circuit 51 is disposed within the millimeter wave transceiver module 5 and at the back of the millimeter wave transceiver antenna array 52. The millimeter wave transceiver circuit 51 may be located at an arbitrary position as long as the millimeter wave transceiver circuit 51 does not block the transmitting and receiving of the millimeter wave. For example, the millimeter wave transceiver circuit 51 may be located above, beneath, on the left, or on the right of the millimeter wave transceiver module 5.

The millimeter wave transceiver antenna array 52 includes at least one row of the millimeter wave transmitting antennas 53 and at least one row of the millimeter wave receiving antennas 54 (the distance between the adjacent rows of the millimeter wave transmitting and receiving antennas 53 and 54 is d, the adjacent distances d can be different from each other). Specifically, the adjacent rows of the millimeter wave transmitting and receiving antennas 53 and 54 can be spaced apart and alternately arranged. Of course, the arrangement of the at least one row of the millimeter wave transmitting or receiving antennas 53 and 54 is not limited to that shown by FIG. 2. The specific arrangement may be chosen as required. For example, the at least one row of the millimeter wave transmitting antennas 53 may be arranged in parallel to each other in one region while the at least one row of the millimeter wave receiving antennas 54 may be arranged in parallel to each other in another region.

In For clarity, FIG. 2 shows one row of the millimeter wave transmitting antennas 53 and one row of the millimeter wave receiving antennas 54 are illustrated herein. However, some implementations use a plurality of rows of millimeter wave transmitting antennas and a plurality of rows of millimeter wave receiving antennas.

The row of the millimeter wave transmitting antennas 53 includes a plurality of millimeter wave transmitting antennas 531 spaced with a first predetermined distance d1 in a row, and the row of the millimeter wave receiving antennas 54 includes a plurality of millimeter wave receiving antennas 541 spaced with a second predetermined distance d2 in a row, wherein the first predetermined distance d1 is identical with or different from the second predetermined distance d2.

For some implementations, the first predetermined distance d1 is identical to the second predetermined distance d2, and the millimeter wave transmitting antenna 531 in one row of the millimeter wave transmitting antennas 53 and the corresponding millimeter wave receiving antenna 541 in its adjacent one row of the millimeter wave receiving antenna array 54 are staggered in a direction (up and down in FIG. 2) perpendicular to the extending direction (left and right in FIG. 2) of one row of the millimeter wave transmitting and/or receiving antennas. In other words, the adjacent millimeter wave transmitting antennas 531 and millimeter wave receiving antennas 541 are not aligned with each other along the up and down direction of the page in FIG. 2, but staggered apart a certain distance along the left and right direction of the page in FIG. 2. Of course, the staggered arrangement as shown in FIG. 2 is one example, and the adjacent millimeter wave transmitting antenna 531 and millimeter wave transmitting antenna 541 may be aligned with each other along the up and down direction of the page in FIG. 2.

The guide rail device 3 may be composed of a single guide rail 31, or can be composed of a plurality of guide rails 31. The latter can enable the millimeter wave transceiver module 5 to move more stably.

The millimeter wave three dimensional holographic scan imaging apparatus 10 may further comprise a data processing device 2. The data processing device 2 is communicated by wire (for example a wire 8) or wireless to the millimeter wave transceiver module 5 to receive scan data from the millimeter wave transceiver module 5 and to generate a millimeter wave holographic image. The millimeter wave three dimensional holographic scan imaging apparatus 10 may further comprise a display device 1. The display device 1 is communicated by wire (for example a wire 7) or wireless to the data processing device 2 to receive and display the millimeter wave holographic image from the data processing device 2.

For some implementations, the data processing device 2 is used to generate a control signal and send the control signal to the driver 4, so that the driver 4 drives the millimeter wave transceiver module 5 to move. In other implementations, the millimeter wave three dimensional holographic scan imaging apparatus 10 may also include a separate controller (not shown) (“controller”) from the data processing device 2, which is used to generate a control signal and send the control signal to the driver 4, so that the driver 4 drives the millimeter wave transceiver module 5 for the scanning movement. The controller is operably connected to the data processing device 2. The controller generates control signals and transmits the control signals to the driver 4 to signal the driver 4 to drive the millimeter wave transceiver module 5 to move along the guide rail device 3.

In the example shown in FIG. 1, the object to be inspected 6 (being a human body as shown in the figure) is located in front of the millimeter wave transceiver module 5. The millimeter wave transceiver module 5 can respectively scan a front face and a back face of the object to be inspected 6, so as to obtain data. Such data is used by the data processing device 2 for generating the entire millimeter wave image of the object to be inspected 6. However, it is possible to only inspect an area of interest.

For some implementations, as shown in FIG. 2, the millimeter wave transceiver module 5 is shaped in a form of rectangular or square box. The skilled person in the art can design the shape of the millimeter wave transceiver module 5 as required.

Another aspect of the disclosed technology is a method for inspecting a human body or article using a millimeter wave three dimensional holographic scan imaging apparatus 10 as described above. The method includes the steps of: locating the object to be inspected such as the human body or the article at an inspection position and setting a millimeter wave transceiver module 5 at its scan beginning position; by means of the driver 4, driving the millimeter wave transceiver module 5 to move from its scan beginning position to its scan end position along a guide rail device 3 continuously or discontinuously to finish scanning to the human body or the article; transmitting the data sampled by the millimeter wave transceiver module 5 during the scanning to a data processing device 2, in the scanning and/or after the scanning; and processing the data received from the millimeter wave transceiver module 5 using the data processing device 2 to generate a millimeter wave holographic image of the human body or the article.

In the above description, the scanning performed by the millimeter wave transceiver module 5 is a plane scan.

As described above, during the scanning process of the millimeter wave transceiver module 5, the scanning performed by the millimeter wave transceiver module 5 can be done at a predetermined speed, a constant speed or a variable speed.

Millimeter wave three dimensional imaging requires scanning in three dimensions: two in terms of space and one in terms of frequency. The two dimensions in terms of space are respectively a scanning parallel to a translational direction of the millimeter wave transceiver module which is achieved by translational movement of the millimeter wave transceiver module, and a scanning perpendicular to the translational direction of the millimeter wave transceiver module which is achieved by switching the current transmitting antenna and the current receiving antenna. The scanning in terms of frequency is accomplished by changing the frequency of the transmitted and received millimeter wave.

When scanning, the millimeter wave transceiver module 5 can be continuously or discontinuously moved along the up and down direction of the page in FIG. 2.

For some implementations, when scanning, the millimeter wave transceiver module 5 may discontinuously move, wherein as for the same position where the millimeter wave transceiver module 5 is located, the two dimensional scanning for the object to be inspected 6 is performed by changing transmitting frequency of the millimeter wave or altering current transmitting or receiving antenna in the millimeter wave transceiver module 5. The whole three dimensional scanning data are obtained by a combination of the two dimensional scanning and the discontinuous movement of the millimeter wave transceiver module 5.

For some implementations, when scanning, the millimeter wave transceiver module 5 continuously moves, and a three dimensional scanning is performed for the object to be inspected 6, by changing a transmitting frequency of the millimeter wave, and altering current transmitting and/or receiving antenna in the millimeter wave transceiver module 5, thereby obtaining the whole three dimensional scanning data from results of the several scans.

For some implementations, the millimeter wave transceiver module 5 transmits information which is obtained by processing the millimeter wave signal received from one or more receiving antennas 541 in the millimeter wave transceiver antennas array 52, to the data processing device 2 in real time, piecewise after it is buffered, or at one time after it is buffered.

For some implementations, the above method may further include, after generating the millimeter wave holographic image of the human body or the article, automatically detecting whether the human body or the article entrains suspected objects, determining the position of the suspected objects, and outputting the results. Entrain is defined as to draw along with or after oneself; for example, a passenger entrains a suspect object if the object is hidden in the passenger's mouth or within the passenger's clothing. This is particularly beneficial to applications in an airport or customs when screening passengers for weapons or contraband substances.

On basis of at least one of the above aspects, the plane scan can be performed for the object to be inspected. Correspondingly, the millimeter wave three dimensional holographic scan imaging apparatus has a relatively small volume. In addition, the imaging apparatus can be made in a rectangle or square shape, and thus has a small footprint and adapts for many occasions, because the millimeter wave transceiver module is shaped in a plate-like profile.

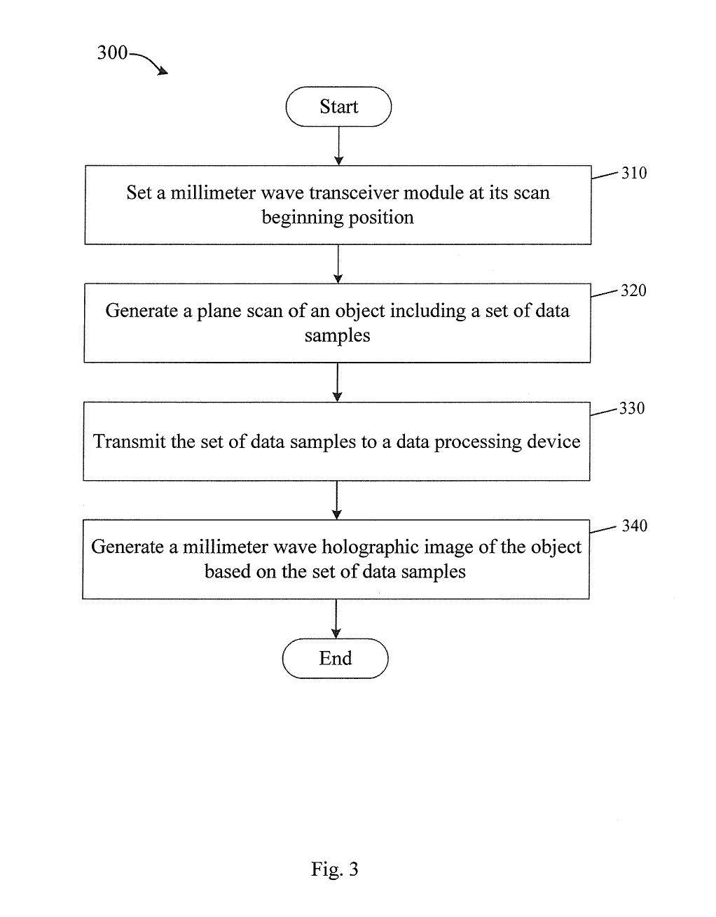

Inspecting a human body or an article using a millimeter wave three dimensional holographic scan imaging apparatus shown in FIG. 1 will now be described with respect to FIG. 3, which is a flowchart illustrating a method 300. At block 310, method 300 sets a millimeter wave transceiver module at a beginning position.

At block 320, method 300 generates a plane scan of the object including a set of data samples. At block 330, method 300 transmits the set of data samples to a data processing device. At block 340, method 300 generates a millimeter wave holographic image of the object based on the set of data samples.

Moreover, the millimeter wave three dimensional holographic scan imaging apparatus in accordance with the disclosed technology has simple and accurate image reconstruction algorithm, thereby improving the imaging speed and accuracy. Further, due to the use of the plane scan type inspection means, it is possible to reduce the length of the antenna array in the millimeter wave transceiver module, and save the cost thereof.

Although the disclosed technology has been explained with reference to the drawings, the embodiments shown in the drawings are only illustrative, instead of limiting the present invention.

The present invention has been described above with reference to one or more embodiments thereof. It should be understood that various modifications, alternations and additions can be made to the device structure by one skilled person in the art without departing from the spirits and scope of the present invention. Moreover, the teachings of the present disclosure may make various modifications which may be adapted for particular situations or materials without departing from the spirits and scope of the present invention. Therefore, the object of the present invention is not limited to the above particular embodiments. The device structure and the manufacture method thereof as disclosed will include all of embodiments falling within the scope of the present invention. the scope of which is defined in the appended claims and their equivalents.

What is claimed is:

1. A millimeter wave three dimensional holographic scan imaging apparatus, comprising:
a millimeter wave transceiver module comprising a millimeter wave transceiver antenna array configured to transmit and receive a millimeter wave signal; and
a guide rail device, to which the millimeter wave transceiver module is connected in slidable form, such that the millimeter wave transceiver module is moveable along the guide rail device to perform a plane scan on an object to be inspected.

2. The millimeter wave three dimensional holographic scan imaging apparatus of claim 1, wherein a transmitting face and a receiving face of the millimeter wave transceiver antenna array both are substantially located on the same plane, wherein the plane is rectangle-shaped or square-shaped in a cross-sectional view.

3. The millimeter wave three dimensional holographic scan imaging apparatus of claim 1 wherein the millimeter wave transceiver module further comprises a millimeter wave transceiver circuit connected to the millimeter wave transceiver antenna array.

4. The millimeter wave three dimensional holographic scan imaging apparatus of claim 1, wherein the millimeter wave transceiver antenna array comprises a row of millimeter wave transmitting antennas and wherein the millimeter wave transceiver antenna array comprises a row of millimeter wave receiving antennas.

5. The millimeter wave three dimensional holographic scan imaging apparatus of claim 4, wherein the row of millimeter wave transmitting antennas comprises a plurality of millimeter wave transmitting antennas spaced apart from each other at a first distance, and wherein the row of millimeter wave receiving antennas comprises a plurality of millimeter wave receiving antennas spaced apart from each other at a second distance.

6. The millimeter wave three dimensional holographic scan imaging apparatus of claim 5, wherein the row of millimeter wave transmitting antennas and the row of millimeter wave receiving antennas are adjacent to each other, and wherein the millimeter wave transmitting antennas in the row of the millimeter wave transmitting antennas and the millimeter wave receiving antennas in the row of the millimeter wave receiving antennas are staggered or aligned, in a direction perpendicular to an extending direction of the row of the millimeter wave transmitting and/or receiving antennas.

7. The millimeter wave three dimensional holographic scan imaging apparatus of claim 1, wherein the millimeter wave three dimensional holographic scan imaging apparatus further comprises a driver, by which the millimeter wave transceiver module is connected with the guide rail device, the driver configured to drive the millimeter wave transceiver module to move along the guide rail device.

8. The millimeter wave three dimensional holographic scan imaging apparatus of claim 1, wherein the millimeter wave three dimensional holographic scan imaging apparatus further comprises a driver, wherein the millimeter wave transceiver module is directly connected with the guide rail device, the driver configured to drive the millimeter wave transceiver module to move along the guide rail device.

9. The millimeter wave three dimensional holographic scan imaging apparatus of claim 1, wherein the guide rail device is arranged along a vertical direction, a horizontal direction or in any oblique direction.

10. The millimeter wave three dimensional holographic scan imaging apparatus of claim 1, wherein the guide rail device comprises one guide rail or a plurality of guide rails parallel to each other.

11. The millimeter wave three dimensional holographic scan imaging apparatus of claim 1, wherein the millimeter wave three dimensional holographic scan imaging apparatus further comprises:
a data processing device configured to receive scan data from the millimeter wave transceiver module, the data processing device configured to generate a millimeter wave holographic image; and
a display device communicated to the data processing device to receive and display the millimeter wave holographic image from the data processing device.

12. The millimeter wave three dimensional holographic scan imaging apparatus of claim 11, wherein the data processing device is configured to generate a control signal and transmit it to the driver to signal the driver to drive the millimeter wave transceiver module to move along the guide rail device.

13. The millimeter wave three dimensional holographic scan imaging apparatus of claim 11, further comprising a controller operably connected to the data processing device, the controller configured to generate a control signal and transmit it to the driver to signal the driver to move along the guide rail device.

14. A method for inspecting an object using a millimeter wave three dimensional holographic scan imaging apparatus as claimed in claim 1, comprising:
setting a millimeter wave transceiver module at its scan beginning position;
generating a plane scan of an object including a plurality of data samples by driving the millimeter wave transceiver module from a scan beginning position to a scan end position along a guide rail;
transmitting the plurality of data samples sampled by the millimeter wave transceiver module during generation of the plane scan to a data processing device; and
generating a millimeter wave holographic image of the object by processing the plurality of data samples.

15. The method of claim 14, further comprising generating three dimensional scanning data by combining two dimensional scanning of the object taken from a plurality of locations of the millimeter wave transceiver module, wherein the millimeter wave transceiver module discontinuously moves, and wherein two dimensional scanning is performed by changing a transmitting frequency of the millimeter wave or altering a transmitted current and/or receiving antenna in the millimeter wave transceiver module.

16. The method of claim 14, further comprising generating three dimensional scanning data by combining two dimensional scanning of the object taken from a plurality of locations of the millimeter wave transceiver module, wherein the millimeter wave transceiver module continuously moves, and wherein a three dimensional scanning is performed by changing transmitting frequency of the millimeter wave, or altering a transmitted current and/or receiving antenna in the millimeter wave transceiver module.

17. The method of claim 14, wherein the millimeter wave transceiver module transmits information which is obtained by processing the millimeter wave signal received from one or more receiving antennas in the row of the millimeter wave transceiver antennas, to the data processing device in real time, piecewise after it is buffered, or at one time transmission after it is buffered.

18. The method of claim 14, further comprising:
detecting an entrained object; and
identifying the position of the entrained object.

19. A millimeter wave three dimensional holographic scan imaging apparatus, comprising:
means for transmitting and receiving a millimeter wave signal; and
means for moving in slidable form the transmitting and receiving means to perform a plane scan on an object to be inspected.

20. The millimeter wave three dimensional holographic scan imaging apparatus, wherein the transmitting and receiving means comprises a millimeter wave transceiver module comprising a millimeter wave transceiver antenna array, and wherein the moving means comprises a guide rail device.
